(19) United States
(12) Patent Application Publication
(10) Pub. No.: US 2006/0121182 A1
(43) Pub. Date: Jun. 8, 2006

(54) Method to facilitate the printing of electronic components

(75) Inventors: Krishna Kalyanasundaram, Elmhurst, IL (US); Paul W. Brazis, South Elgin, IL (US); Daniel R. Gamota, Palatine, IL (US); Jie Zhang, Buffalo Grove, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola Inc.

(21) Appl. No.: 11/004,080

(22) Filed: Dec. 3, 2004

(51) Int. Cl. B05D 5/12

(52) U.S. Cl. 427/58; 427/8

(57) ABSTRACT

Data regarding printing instructions for an active electronic component are provided (11). These printing instructions will typically comprise instructions regarding the location, geometry, size, orientation, and functional inks used for various component layers as correspond to the electronic component, and are without reference to a specific printing system. This data is then modified (12) as a function of one or more operational proclivities of a particular high throughput additive printing system to provide modified instructions that, when employed to effect the printing of the active electronic component, will improve the resultant yield as compared to the unmodified data.

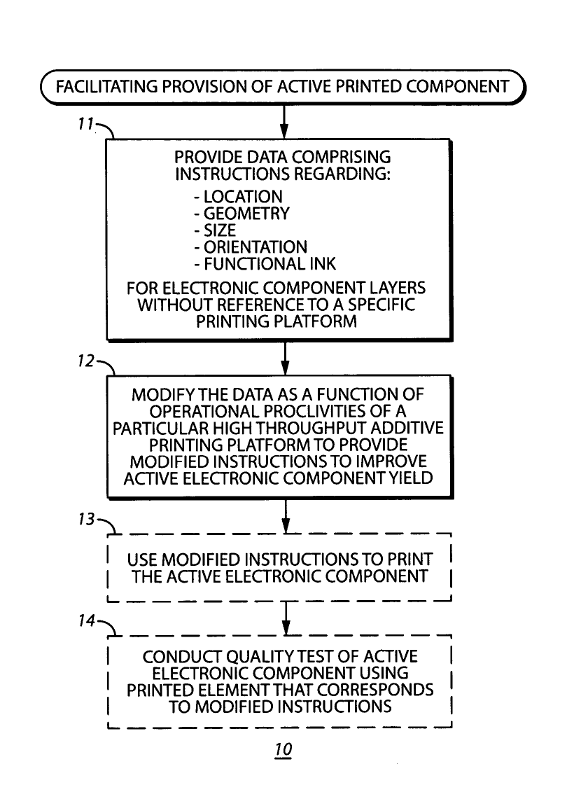

### TECHNICAL FIELD

This invention relates generally to additive printing processes and systems.

### BACKGROUND

Various methodologies exist to permit the fabrication of various kinds of active electronic components. For example, semiconductor fabrication techniques involving the selective and ordered deposition and removal of various materials are frequently employed when fabricating diodes, transistors of various kinds, and so forth. For many purposes, such techniques (and their associated materials) serve adequately. Nevertheless, such techniques are not necessarily suitable for all purposes. For example, the relatively high costs of design and fabrication associated with such techniques tend to discourage their application with relatively low volume applications and/or when extremely low cost represents a critical requirement. As another example, in some cases such subtractive techniques are considered less environmentally friendly due to higher material waste.

More recently, researchers are exploring the possibility of printing active electronic components (as well as passive electronic components) using only, or substantially only, additive printing processes. Such components (and/or circuits comprised of such components) can include, for example, but are not limited to, reflective displays, emissive displays, lighting, photovoltaics, sensors, radio frequency devices, and power sources, to name a few. So-called functional inks that demonstrate desired electrical properties are now available to use in such processes. For example, functional inks have been identified to serve as electrical conductors, as semiconductor materials, and so forth. Using such functional inks in conjunction with additive printing systems holds forth a possibility of fabricating electronic components, including active electronic components, in a manner quite different from past practices.

At present, however, numerous obstacles exist to widespread usage of such techniques. Conceptually, such a fabrication approach appears to present significant cost advantages as compared to semiconductor fabrication techniques. In practice, however, costs tend to prove surprisingly high. Low productivity throughput contributes in large part to these discouraging results. Such low fabrication rates are owing in part to the fact that electronic component designers and electronic circuit designers configure their designs via one means of expression, and printers approach their craft with a different process and means of expression. These divergent views and sets of practices can and do lead to miscommunications and misunderstandings that ultimately lead to ineffectual resultant printed components and circuits. Such inefficient and awkward processes in turn lead to uneconomically low throughput.

At least part of this problem is further exacerbated by the fact that printing systems can and will vary from one model to another, and even from one system to another within a given model. And of course significant control variations exist when comparing differing printing techniques (such as, for example, when comparing offset printing against flexography and so forth). Graphic arts printers are typically familiar with and are trained to compensate for such variations as they relate to printing resolution, distortion, ink thickness variations, and the like. Component and circuit designers, on the other hand, typically have no familiarity with such variables as pertain to the additive printing arts and hence are not to be expected to offer designs that are friendly in that regard.

Consider further that a standard graphics printing workflow entails three primary actions; pre-press, on-press, and post-press. During pre-press, printing technicians address the design of the item to be printed, layout and/or typesetting issues, plate and/or image issues, and so forth. On-press comprises the additive application of inks via impact or non-impact delivery mechanisms. And post-press typically comprises a variety of backend activities, including testing, die cutting, binding, collating, packaging, and so forth. Unfortunately, none of these traditional actions provides for the kind of additional operations that can become necessary when printing electronic components and circuits.

As a result, printed components and circuits, when successfully demonstrated, tend to result from painstaking effort and typically tend to rely upon very slow printing processes that yield, at best, dozens of printed sheets per hour. When compared against the thousands or hundreds of thousands of sheets per hour that available printing systems are capable of delivering in the graphic arts sector, these meager results are discouraging indeed. Notwithstanding such clear differences in result, however, it is also clear that one cannot expect to simply speed up present practices and achieve useful and economic levels of throughput.

### BRIEF DESCRIPTION OF THE DRAWING

The above needs are at least partially met through provision of the method to facilitate the printing of electronic components described in the following detailed description, particularly when studied in conjunction with the drawing, which comprises a flow diagram as configured in accordance with various embodiments of the invention.

Skilled artisans will appreciate that common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, a method to facilitate provision of an active substantially fully printed electronic component on a printing substrate using a particular high throughput additive printing system first provides data comprising instructions regarding location, geometry, size, orientation, and functional ink content of various active electronic component layers to be printed on the printing substrate without reference to a specific printing system. Those data are then modified as a function, at least in part, of one or more operational proclivities of the particular high throughput additive printing system to provide modified instructions regarding at least one of location, geometry, size, orientation, and functional ink content to thereby improve yield of the active electronic component.

So configured, component and/or circuit designs can be rendered and laid out with primary attention being directed to those design criteria already well understood by the technicians who typically originate such designs. Notwithstanding this starting point, the resultant defining data is then modified as necessary or useful to permit viable high-speed printing process to be employed when fabricating the corresponding components. This in turn comprises an efficient and effective approach to facilitate the fabrication of printed electronics-based products in a manner that significantly leverages existing printing industry infrastructure.

Viewed generally, this approach fits well with an overall approach to component fabrication that entails:

Creating a printable electronic product design;

Converting that design to a printable layout;

Preparation of a master image;

Fabrication of a product using the design while using high speed additive printing processes;

Testing of the resultant product;

Singulation;

Packaging;

Completion or use of the resultant component or circuit as a final product.

In particular, these teachings are readily applied to permit component/circuit technicians to provide an image file specifying the proposed design and layout of the component or circuit of interest. That design and layout is then modified, as a secondary step or integral to the aforementioned action as may best suit the needs of a given application, to accommodate the specifics of a given high speed additive printing system to thereby permit reliable and low cost fabrication at presently unheard-of production speeds. These teachings effectively permit electronics design input to be compatible with existing graphic arts print flow in order to leverage speed and efficiency while also making potent use of widespread presently available legacy infrastructure.

These and other benefits may become more evident upon making a thorough review and study of the following detailed description. Referring now to the drawing, various approaches to facilitate provision of an active substantially fully printed electronic component on a printing substrate using a particular high throughput additive printing system will be described. Those skilled in the art will appreciate that these teachings are applicable with a wide variety of printing substrates including flexible substrates such as, but not limited to, pulp-based substrates (i.e., paper and rag stock of various weights and content, cardboard stock, and so forth), fabric or other textiles, polyester substrates, and polycarbonate substrates, to name a few.

Pursuant to a preferred approach 10, these teachings accept the provision 11 of data comprising instructions regarding the location, geometry, size, orientation, and functional ink content (where the content can refer, for example, to specific functional ink material, density, thickness of application size, desired electrical property, and so forth) of the various active layers that are to be printed on the printing substrate to form one or more active electronic components. Further pursuant to a preferred approach, one provides some or all of this data without reference to a specific printing system. That is, although the data essentially defines a set of printing instructions (as versus being, for example, merely a schematic representation of a given component or circuit), these instructions are essentially neutral with respect to their appropriateness for any given specific printing system or process. Such data may also include other instructions as well, of course, including but not limited to resolution information, color specifications, and even graphic (as versus functional) elements, to suggest but a few.

These instructions preferably comprise both a printing compatible format and an electronic design compatible format. Useful formats in this regard include, but are not limited to, PostScript data, Portable Document Format (PDF) data, raster image process data, Gerber data, Tagged Image File Format (TIFF) data, bitmap data, raster image data, and so forth. Such formats are generally well understood in the art. Additional formats are no doubt to be expected in the future. These teachings are not particularly sensitive to selection of any given such format. For all these reasons, and for the sake of brevity and the preservation of focus, no further elaboration need be presented here regarding such data formats.

Pursuant to a preferred process, this data is then modified 12 as a function, at least in part, of the operational proclivities of a particular high throughput additive printing system (or systems, when multiple systems are used to embody the fabrication process) to thereby provide modified instructions regarding at least one of layer location, geometry, size, orientation, and functional ink content to thereby improve the corresponding fabrication yield of the printed active electronic component.

The operational proclivities so accommodated can be many and varied. Some of the more typical proclivities that are suitable to consider in this regard include, but are not limited to:

ink curing latency variations;

print resolution variations;

print interface accuracy variations;

print registration variations;

ink deposition density variations;

ink fluid property variations; and

ink functional property variations;

to name but a few illustrative examples.

Such proclivities can and will vary not only from process to process and model to model but also from individual system to system. For example, a given printing system may tend to deposit ink in slightly thicker (or thinner) quantities at a certain location on a printing substrate. Such proclivities are knowable and typically are known to the system operators who gain such insight through repeated interaction and usage of their respective systems. Pursuant to these teachings, information regarding such proclivities is leveraged to modify a more generic set of printing instructions to thereby tend to effect fabrication of an electronic component having an improved likelihood of operating in a satisfactory manner.

It should be noted that, in many cases, the proclivities of interest and suitable applications for these purposes may effect considerably different results when applied in the context of electronic component fabrication. Ink density and/or depth variations produces one set of concerns and corresponding artifacts when viewed from the standpoint of a graphic result, and a considerably different set of concerns when viewed from the standpoint of an active electronic component. For example, the depth of a functional ink comprising a dielectric material must often be within a relatively narrow range of allowable values; a dielectric layer that is too thick or too thin can render the corresponding electronic component ineffective or outside tolerance for its intended use notwithstanding that the corresponding graphic result otherwise appears identical as a working result.

Modification of the printing instruction data may comprise the making of changes to the provided instructions and/or the inclusion of additional instructions. As but one example of the latter, an added printing instruction may be included regarding inclusion of at least one test strip to be printed on the printing substrate. To illustrate, a test strip may be added to a particular area of the printing substrate to permit an in-line or post-fabrication density inspection of the test strip. When the test strip is printed using a functional ink that is otherwise occluded by other layers (such as a dielectric layer) in the functional component itself, such a test strip permits a relatively easy and effective quality check regarding the thickness of this printed layer and hence the likely operability of the corresponding electronic component layer itself.

Modifications to the printing instructions data can be varied as appropriate to meet the needs and/or opportunities presented by a given application. As one example, such modifications can comprise changing an instruction regarding a specific location to print a specific one of the active component layers on the printing substrate. Such a change may be used, for example, to accommodate a proclivity of the printing system regarding ink deposition accuracy. As one simple illustration, a given system may exhibit better accuracy in an axial direction of the printing process as versus a lateral direction. Given this proclivity, the printing instructions may be modified to re-orient certain elements to take advantage of the improved accuracy in one printing orientation and to avoid the potentially impaired results that occur when printing favors the other orientation.

As another example, such modifications can comprise changing an instruction regarding a specific size to print a specific one of the active electronic component layers on the printing substrate. Such a change may be used, for example, to accommodate a proclivity of the printing system regarding sizing and/or scaling accuracy. For instance, a printing system may be known to universally scale (upwardly or downwardly) a given input. As another illustrative instance, a given printing system may be known to scale (upwardly or downwardly) a given input with respect to a given direction or orientation. As yet another illustrative instance, a given printing system may be known to present sizing variations in certain fields of a printing substrate but not in other fields that comprise the printing substrate. The modifications to the printing instruction proffered pursuant to these teachings can ameliorate the potential consequences to operability of the resultant corresponding active electronic component.

As another example, such modifications can comprise changing an instruction regarding a specific geometry to use when printing a specific one of the active electronic component layers on the printing substrate. Such a change may be used, for example, to accommodate a proclivity of the printing system regarding printing accuracy as corresponds to the geometry of the object being printed. For instance, a given printing system may be known to print straight lines (and hence rectangles, triangles, and the like) with precision but to print curved lines (including circles) with less precision. Given such circumstances, these teachings can be employed to modify instructions to print, for example, a certain layer of an active electronic component as a circle to require instead the printing of a box to serve as that particular layer. When effecting such a change, of course, the graphic result will be considerably different than the input instructions would otherwise provide. These teachings, however, are concerned with the resultant electrical performance of the printed component. As a result, while such a modification may seem highly counterintuitive within the ordinary printing arts, pursuant to these teachings such a modification can represent the difference, in a given setting, between a high yield result and a low yield result.

If desired, these modifications can further comprise the specification of instructions regarding the inclusion of specified non-electrically functional graphic elements on the printing substrate (including but certainly not limited to alphanumeric graphic elements). Such graphic elements may be helpful to facilitate subsequent component testing, component singulation, user interaction with the resultant component or circuit, and the like. These graphic elements, when provided, may be comprised of functional inks but may also, of course, be comprised of ordinary graphic inks that possess no particularly useful electrical performance characteristics.

The above illustrative examples comprise a non-exhaustive presentation. Those skilled in the art will recognize that numerous other printing instructions may be advantageously modified to leverage and/or avoid the deleterious impact of one or more proclivities of a given printing system.

These modified instructions are then available to use 13 with the particular high throughput additive printing system to print the active electronic component on the printing substrate. These teachings are readily applicable for use with a wide variety of printing systems (including systems using either contact (or imprint) or non-contact (or non-imprint) printing methodologies), including but not limited to:

a flexo (or flexography) printing system;

a gravure printing system;

a screen printing system;

a lithography printing system;

a micro-contact printing system;

a nano-imprint lithography printing system;

a liquid coating printing system;

a microdispensing printing system;

a jet printing system;

a spray coating printing system.

These teachings are also applicable for use with multi-technology systems. That is, printing systems that integrate and incorporate more than one type of printing technology. For example, these teachings are suitable for use with additive printing systems that comprise two or more of (but that are not limited to) a flexo printing system, a gravure printing system, a screen printing system, and an offset printing system.

These teachings are also suitable for use in conjunction with downstream testing, including the conducting 14 of a quality test as corresponds to the active electronic component using at least one printed element that corresponds to a modification of the data as described above. As one simple example, one can conduct a quality test with respect to a test strip that is added via the modification step to assess the likely operability of a given component and/or a portion of a given component.

The modification steps set forth above can be effected through use of dedicated personnel (such as a typesetter who supplements or substitutes his or her ordinary layout criteria and rules with standards that are compatible with these teachings), through use of a rules-based software design process (that guides, limits, or otherwise facilitates the modification of a given component or circuit layout in accord with these teachings), or such other mechanism as may be appropriate to the needs and/or capabilities of a given setting.

So configured, standard printing processes are readily employed to effect the high-speed fabrication of printed active electronic components. These teachings can be usefully employed with both sheet-fed and roll-based printing systems. This resultant improvement in output yield, by orders of magnitude, over presently demonstrated techniques should aid considerably in bringing this promising new technology of substantially fully printed electronic components and circuits to a commercially viable status. This, of course, will permit a given printing establishment to print active electronic components on corresponding printing substrates as described and to sell that resultant output at what should represent a favorable return.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method to facilitate provision of an active substantially fully printed electronic component on a printing substrate using a particular high throughput additive printing system, the method comprising:
providing data comprising instructions regarding location, geometry, size, orientation, and functional ink content of various active electronic component layers to be printed on the printing substrate without reference to a specific printing system;
modifying the data as a function, at least in part, of operational proclivities of the particular high throughput additive printing system to provide modified instructions regarding at least one of location, geometry, size, orientation, and functional ink content to thereby improve yield of the active electronic component.

2. The method of claim 1 wherein providing data comprising instructions regarding location, geometry, size, orientation, and functional ink content of various active electronic component layers further comprises providing instructions regarding location, geometry, size, orientation, and functional ink content of various active electronic component layers as comprise a plurality of active electronic components.

3. The method of claim 2 wherein providing data comprising instructions regarding location, geometry, size, orientation, and functional ink content of various active electronic component layers as comprise a plurality of active electronic components further comprises providing data comprising instructions regarding location, geometry, size, orientation, and functional ink content of various active electronic component layers as comprise a plurality of active electronic components that, as a group, comprise an electronic circuit.

4. The method of claim 1 wherein the operational proclivities comprise at least one of:
ink curing latency variations;
print resolution variations;
print interface accuracy variations;
print registration variations;
ink deposition density variations.
ink fluid property variation
ink functional property variation

5. The method of claim 1 wherein modifying the data further comprises adding additional instructions to the data.

6. The method of claim 5 wherein adding additional instructions to the data further comprises adding instructions regarding inclusion of at least one test strip to be printed on the printing substrate.

7. The method of claim 1 wherein modifying the data further comprises modifying an instruction comprising at least one of a printing and an electronic design compatible format.

8. The method of claim 7 wherein modifying an instruction comprising at least one of a printing and an electronic design compatible format further comprises modifying an instruction as regards at least one of:
PostScript data;
portable document format data;
raster image process data;
Gerber data;
tagged image file format data;
bitmap data;
raster image data.

9. The method of claim 1 wherein modifying the data further comprises changing an instruction regarding a specific location to print a specific one of the active electronic component layers on the printing substrate.

10. The method of claim 1 wherein modifying the data further comprises changing an instruction regarding a specific size to print a specific one of the active electronic component layers on the printing substrate.

11. The method of claim 1 wherein modifying the data further comprises changing an instruction regarding a specific geometry to use when printing a specific one of the active electronic component layers on the printing substrate.

12. The method of claim 1 wherein modifying the data further comprises adding instructions regarding inclusion of specified non-electrically functional graphic elements on the printing substrate.

13. The method of claim 12 wherein the specified non-electrically functional graphic elements further comprise alphanumeric graphic elements.

14. The method of claim 1 and further comprising:
using the modified instructions with the particular high throughput additive printing system to print the active electronic component on the printing substrate.

15. The method of claim 14 and further comprising:
conducting a quality test as corresponds to the active electronic component using at least one printed element that corresponds to a modification of the data as a function, at least in part, of the operational proclivities of the particular high throughput additive printing system.

16. The method of claim 14 further comprising:
selling the active electronic component on the printing substrate.

17. The method of claim 1 wherein the printing substrate comprise a flexible printing substrate.

18. The method of claim 17 wherein the flexible printing substrate comprises one of:
a pulp-based substrate;
a polyester substrate;
a polycarbonate substrate.

19. The method of claim 1 wherein the particular high throughput additive printing system comprises one of:
a flexo printing system;
a gravure printing system;
a screen printing system;
a lithography printing system;
a micro-contact printing system;
a nano-imprint lithography printing system;
a liquid coating printing system;
a microdispensing printing system;
a jetting printing system;
a spray coating printing system.

20. The method of claim 19 wherein the particular high throughput additive printing system comprises at least two of:
a flexo printing system;
a gravure printing system;
a screen printing system;
an offset printing system.
